(19) United States
(12) Patent Application Publication
(10) Pub. No.: US 2009/0110468 A1
(43) Pub. Date: Apr. 30, 2009

(54) NEEDLE TYPE BALLPOINT PEN CHIP AND THE MANUFACTURING METHOD FOR A NEEDLE TYPE BALLPOINT PEN CHIP

(75) Inventors: Osamu SUGANO, Satte-shi (JP); Hidemaro Aoyagi, Koga-shi (JP); Yuji Sugano, Shimotsuga-gun (JP); Takugo Iwama, Saitama-shi (JP)

Correspondence Address: MORRISON & FOERSTER LLP, 1650 TYSONS BOULEVARD, SUITE 400, MCLEAN, VA, 22102, US

(73) Assignee: Zebra Co., Ltd., Tokyo (JP)

(21) Appl. No.: 12/255,511

(22) Filed: Oct. 21, 2008

(30) Foreign Application Priority Data
Oct. 22, 2007 (JP) P2007-274176

(51) Int. Cl. B43K 7/10; B23P 11/00

(52) U.S. Cl. 401/216; 29/441.1

(57) ABSTRACT

The object of the present invention is to provide a needle type ballpoint pen chip capable of achieving smooth writing. The needle type ballpoint pen chip of the present invention has a very small diameter, the diameters of the ball and the ink flow hole are naturally also small. In order to achieve smooth writing, it is therefore necessary to minimize to the greatest extent possible deviation in the position of the center axis line of the ink flow hole in relation to the center of the ball. To achieve the object, in the needle type ballpoint pen chip of the present invention, a solid cylindrical steel material S with a diameter of approximately 1 mm or less, rather than a pipe material, is used as its base material, and an ink flow hole is formed by performing drill cutting processing on this steel material.

### BACKGROUND OF THE INVENTION

1. Field of the Invention

The present invention relates to a metallic (for example, stainless steel) needle type ballpoint pen chip provided on the front end of a refill called a inner lead.

2. Related Background Art

Japanese Patent Application Laid-open Publication No. 2006-62175 is representative of the prior art for the present invention. With the manufacture of a needle type ballpoint pen chip described in this publication, a metallic capillary (pipe material) is used. After a center pin is inserted into this metallic capillary, the capillary is divided in two at its center by means of a rotation roller, whereafter the center pin is removed from the capillary. This cutting process is used to form the front end of the capillary into a conical shape by means of the rotation roller. A conical guide pin is then inserted through the front end of the capillary, and three ball receiving seats are formed by means of a punch in the radial direction from the exterior of the capillary. After the ball receiving seats have been formed, a ball is loaded from the front end port of the capillary, and the ball loading process is completed by caulking the front end of the capillary. With this type of needle type ballpoint pen chip, capillaries are used as a base material due to their small diameter and, more specifically, needle type pen chips with a diameter of 1 mm or less generally use capillaries (pipe material) as their base material.

With the above-described conventional needle type ballpoint pen chip, the center hole of the capillary becomes misaligned in many cases due to error in the production of the capillary itself which is used as the base material. When this type of capillary is used as the base material for needle type ballpoint pen chips, the center axis line of the center hole forming an ink flow hole deviates in position relative to the center of the ball even if the ball is arranged on the center axis line of the capillary, thereby allowing a thin spot of ink to occur easily, hence, making smooth writing difficult. This problem is particularly prevalent with ballpoint pens using gel ink containing pigments.

### SUMMARY OF THE INVENTION

The object of the present invention is to provide a needle type ballpoint pen chip achieving smooth writing.

The needle type ballpoint pen chip of the present invention comprises: a chip body provided with a ball at the front end thereof; and an ink flow hole extending along the center axis line of the chip body, wherein the ink flow hole is formed by performing drill cutting processing on a solid cylindrical steel material with a diameter of approximately 1 mm or less.

A manufacturing method for a needle type ballpoint pen chip of the present invention is a manufacturing method for a needle type ballpoint pen chip provided with a ball at the front end of a chip body, comprising: a preparing step of preparing a solid cylindrical steel material with a diameter of approximately 1 mm or less; and a forming step of forming an ink flow hole extending along the center axis line of the chip body by cutting the cylindrical steel material with a drill.

Unlike arrow type ballpoint pen chips formed in the shape of arrows, the needle type ballpoint pen chip of the present invention is formed in a needle-like long and thin shape. The needle type ballpoint pen chip has a very small diameter, and if the diameter is 1 mm or less, the diameters of the ball and the ink flow hole are naturally also small. In order to achieve smooth writing, it is therefore necessary to minimize to the greatest extent possible deviation in the position of the center axis line of the ink flow hole in relation to the center of the ball. Accordingly, in the needle type ballpoint pen chip of the present invention, a solid cylindrical steel material of approximately 1 mm or less, rather than a pipe material, is used as its base material, and an ink flow hole is formed by performing drill cutting processing on this steel material.

Preferably, the ink flow hole is formed from a plurality of cylindrical hole parts with differing diameters, and it is preferably that the diameters of the plurality of cylindrical hole parts be arranged from large to small from the proximal end to the front end of the chip body.

As the diameter of the ink flow hole is made to be small, a drill with a small diameter must be used when the solid steel material is drilled, and out of consideration of the possible breaking or bending of the drill, the ink flow hole is formed by performing drill cutting processing two or more times, rather than only once. When the ink flow hole is formed using drills with the same diameter, each succeeding drill blade is abraded at a high speed by the drill hole wall face formed by each preceding drill blade, thus severely degrading the service life of the drill and allowing the drill to be easily broken. In the present invention, therefore, cutting is performed as the drill diameter is reduced stepwise.

It is additionally preferable that the diameter difference of the hole parts adjacent to each other be approximately 0.02 mm.

In this manner, the adjacent hole parts have a uniform diameter differences and the diameter difference of the hole parts is approximately 0.02 mm, thereby allowing the inner wall surface of the ink flow hole to be smoothly finished compared to the case with a diameter difference of approximately 0.01 mm or with no diameter difference. Consequently, ink can steadily flow through the inside of the ink flow hole. In addition, cutting efficiency can be increased with drill service life extended.

Thus, smooth writing is achieved according to the present invention.

### BRIEF DESCRIPTION OF THE DRAWINGS

FIG. 1 is a cross-sectional drawing of a ballpoint pen to which has been applied the needle type ballpoint pen chip of the present invention.

FIG. 2 is a cross-sectional drawing of a refill provided with the needle type ballpoint pen chip of the present invention at its front end.

FIG. 3 is a cross-sectional drawing of one embodiment of the needle type ballpoint pen chip of the present invention.

FIG. 4 is a perspective view of a steel material.

FIG. 5 is a flow chart showing one embodiment of the manufacturing method for a needle type ballpoint pen chip of the present invention.

### DESCRIPTION OF THE PREFERRED EMBODIMENTS

The preferred embodiments of the needle type ballpoint pen chip and the manufacturing method for a needle type ballpoint pen chip of the present invention is hereinafter explained in detail in reference to the drawings. It should be noted that penpoint side of the ballpoint pen is explained below as being the “front side” thereof.

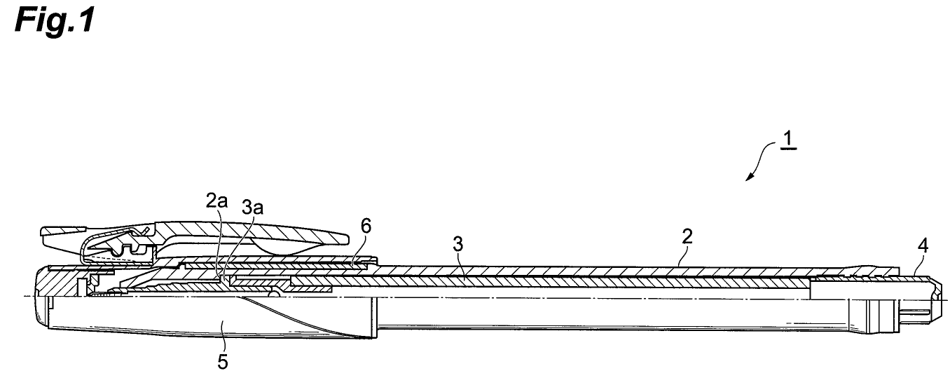

As shown in FIG. 1, a cap type ballpoint pen 1 comprises a cylindrical barrel 2 made of a transparent resin, a refill 3 loaded in barrel 2, a tail plug 4 made of a resin and fixed onto the back end of the barrel 2, a cap 5 functioning as a lid over the front end side of the barrel 2, and a rubber slip prevention grip 6 fixed onto the outer peripheral front side of the barrel 2.

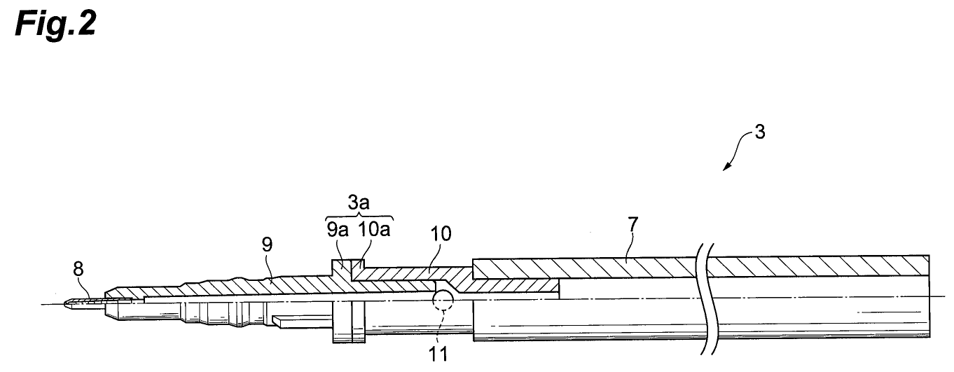

As shown in FIG. 2, the refill 3 comprises a tube 7 filled with gel ink containing a pigment, a joint 9 made of a transparent resin and fixed with a needle type ballpoint pen chip 8 on its front end, a back joint 10 connecting the front end side of the tube 7 and the back end side of the joint 9, and a ball valve 11 preventing a reverse flow of ink by opening and closing the back end opening of the joint 9. The refill 3 is inserted through the back end of the hollow portion of the barrel 2, and a flange 3a provided on the front side of the refill 3 abuts on a step part 2a inside the barrel 2 to fasten the tail plug 4, thereby fixing the refill 3 onto the barrel 2 (see FIG. 1). The flange 3a is formed from the butt adhesion between a flange 9a of the joint 9 and a flange 10a of the back joint 10.

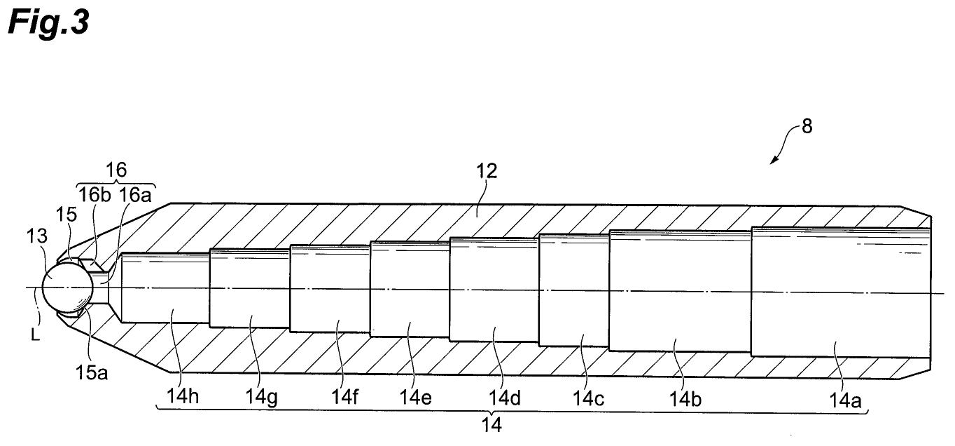

As shown in FIG. 3, the needle type ballpoint pen chip 8 comprises a chip body 12 formed from a metal (for example, SF20T stainless steel), and a ball 13 with a diameter of 0.3 or 0.4 mm loaded into the front end of the chip body 12. The entire length of the chip body 12 is approximately 5 mm, with a diameter of approximately 1 mm or less, and an ink flow hole 14 extending along a center axis line L is provided in the chip body 12.

Unlike arrow type ballpoint pen chips formed in the shape of an arrow tip, the needle type ballpoint pen chip 8 is formed in a needle-like long and thin shape. The needle type ballpoint pen chip 8 has a very small diameter, and particularly if the diameter is 1 mm or less, the diameters of the ball 13 and the ink flow hole 14 are naturally also small. In order to achieve smooth writing, it is therefore necessary to minimize to the greatest extent possible deviation in the position of the center axis line of the ink flow hole 14 in relation to the center of the ball 13.

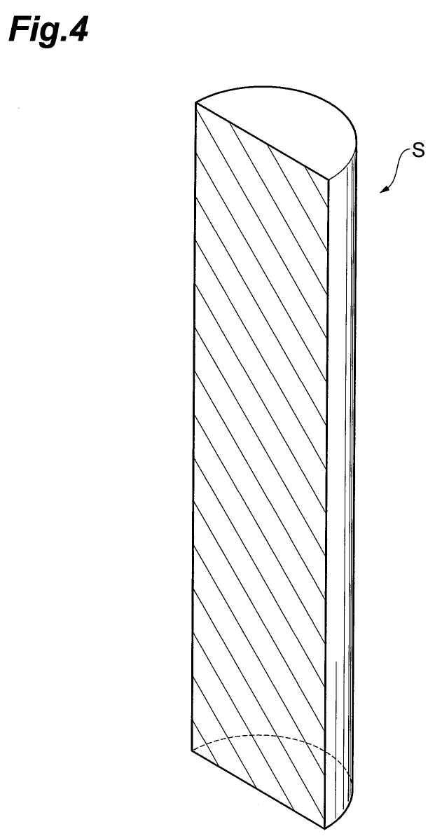

Therefore, the ink flow hole 14 is formed by utilizing as its base material a cylindrical steel material S (see FIG. 4) which is a solid metal (for example, SF20T stainless steel) with a diameter of approximately 1 mm or less rather than using a pipe material, and performing drill cutting processing on this cylindrical steel material. This ink flow hole 14 comprises eight cylindrical hole parts 14a through 14h, and the diameter of each of the hole parts 14a through 14h decreases stepwise by approximately 0.02 mm from the back end to the front end of the chip body 12.

As the diameter of the ink flow hole 14 is made to be small, a drill with a small diameter must be used when the solid steel material S is drilled, and out of consideration of the possible breaking or bending of the drill, the ink flow hole 14 is formed by performing drill cutting processing two or more times (eight times in the present embodiment), rather than only once. When the ink flow hole 14 is formed using drills with the same diameter, each succeeding drill blade is abraded at a high speed by the drill hole wall face formed by each preceding drill blade, thus severely degrading the service life of the drill and allowing the drill to be easily broken. In the present invention, therefore, drill cutting process is divided into 8 stages, and drill cutting is performed as the drill diameter is reduced stepwise, and as a result of drilling, the ink flow hole 14 comprising a plurality of (eight) cylindrical hole parts 14a through 14h with differing diameters is formed.

Additionally, the adjacent hole parts 14a through 14h have a uniform diameter difference and the diameter difference of the hole parts 14a through 14h is approximately 0.02 mm, thereby allowing the inner wall surface of the ink flow hole 14 to be smoothly finished compared to the case with a diameter difference of approximately 0.01 mm or with no diameter difference. Consequently, ink can steadily flow through the inside of the ink flow hole 14, contributing to smooth writing. In addition, cutting efficiency can be increased with drill service life extended.

Moreover, a ball receiving space 15 formed by drill cutting processing is provided on the front end side of the ballpoint pen chip 8, and this ball receiving space 15 communicates with the most front end hole part 14h via an ink outflow control part 16 formed by drill cutting processing. This ink outflow control part 16 comprises a cylindrical center hole 16a forming the main flow of ink and formed by drill cutting processing, and three branch flow channels 16b which project from the center hole 16a in the radial direction and which are formed at even intervals in the circumferential direction of the center hole 16a.

Furthermore, the ball 13 is loaded into a drill hole formed as a result of the drill processing of the front end of the steel material S, and is rotatably held in the ball receiving space 15 through the subsequent process of caulking the front end and impressing process in which a pressure is applied to the ball from the top and the curvature of the ball is transferred onto a bearing surface 15a. The surface on which drill cutting processing has been performed is impressed, thus the pressure during the impressing process can be maintained uniformly throughout the product, therefore increasing precision to a greater degree in comparison to the conventional bearing surface formed by means of a punch from the exterior of the pipe (see Japanese Patent Application Laid-open Publication No. 2006-62175 cited above). This, in turn, increases the precision with which ball 13 rolls, contributing to smooth writing, as well as to uniform quality of the product as a whole.

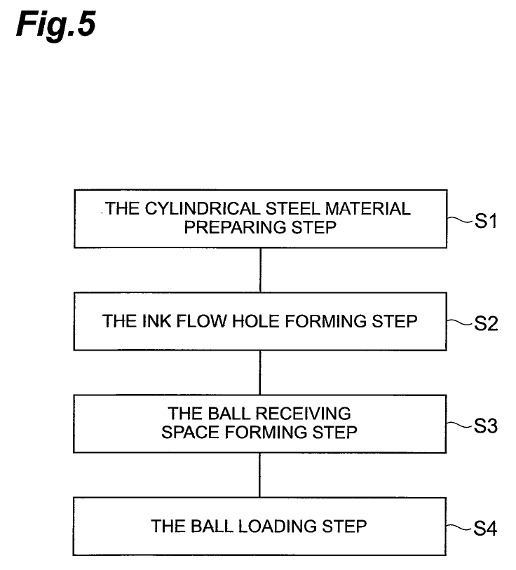

As presented above, the manufacturing method for a needle type ballpoint pen chip of one embodiment comprises a preparing step S1 in which a solid cylindrical steel material with a diameter of approximately 1 mm or less is prepared, a first forming step S2 in which the ink flow hole is formed by cutting the cylindrical steel material with a drill, a second forming step S3 in which the ball receiving space 15 is formed by a drill cutting processing, and a loading step S4 in which the ball 13 is loaded into the ball receiving space 15 (FIG. 5). In the first forming step S2, cutting process with the drill is divided into a plurality of stages and cutting is performed as a diameter of the drill is reduced stepwise.

Concretely, with the aforementioned ballpoint pen chip 8, if the chip body 12 is approximately 0.8 mm in diameter and approximately 5 mm in length and the diameter of the ball 13 is 0.3 mm, the diameter of the hole part 14a will be 0.56 mm, the diameter of the hole part 14b will be 0.54 mm, the diameter of the hole part 14c will be 0.52 mm, the diameter of the hole part 14d will be 0.50 mm, the diameter of the hole part 14e will be 0.48 mm, the diameter of the hole part 14f will be 0.46 mm, the diameter of the hole part 14g will be 0.44 mm, the diameter of the hole part 14h will be 0.42 mm, and the diameter of the center hole 16a will be 0.17 mm. Additionally, if the diameter of the ball 13 is 0.4 mm, the diameter of the center hole 16a will be 0.25 mm. These types of measurements are necessary in achieving smooth writing.

The present invention is not necessarily limited to the above embodiments. For example, the adjacent hole parts 14a through 14h need not necessarily be uniform in diameter difference and the number of the hole parts is not limited to eight. The diameter difference of the adjacent hole parts 14a through 14h is not limited to the above embodiments so long as it is approximately 0.02 mm or more, and it may be decided based on the number of hole parts utilized. Furthermore, there need not necessarily be three branch flow channels 16b, but there may be any number of such channels of two or more, according to the characteristics of the ink used.

Additionally, the present embodiment utilizes a cylindrical steel material S separated from a wire material with a diameter of 1 mm or less, but a cylindrical steel material S with a diameter of 1 mm or less may also be utilized which is obtained by reducing an external diameter of a material with a diameter exceeding 1 mm by cutting processing.

What is claimed is:

1. A needle type ballpoint pen chip, comprising:
a chip body provided with a ball at the front end thereof; and
an ink flow hole extending along the center axis line of the chip body,
wherein the ink flow hole is formed by performing drill cutting processing on a solid cylindrical steel material with a diameter of approximately 1 mm or less.

2. The needle type ballpoint pen chip according to claim 1, wherein the ink flow hole comprises a plurality of cylindrical hole parts with differing diameters, with the diameters of the plurality of cylindrical hole parts arranged from large to small from the back end to the front end of the chip body.

3. The needle type ballpoint pen chip according to claim 2, wherein the diameter difference of the hole parts adjacent to each other is approximately 0.02 mm.

4. A manufacturing method for a needle type ballpoint pen chip provided with a ball at the front end of a chip body, comprising:
a preparing step of preparing a solid cylindrical steel material with a diameter of approximately 1 mm or less; and
a forming step of forming an ink flow hole extending along the center axis line of the chip body by cutting the cylindrical steel material with a drill.

5. The manufacturing method for a needle type ballpoint pen chip according to claim 4, wherein in the forming step, cutting process with the drill is divided into a plurality of steps and cutting is performed as a diameter of the drill is reduced stepwise.
